(19) United States
(12) Patent Application Publication
(10) Pub. No.: US 2011/0069804 A1
(43) Pub. Date: Mar. 24, 2011

(54) Jet Pump Slip Joint Modification for Vibration Reduction

(75) Inventor: John Joseph Lynch, Morgan Hill, CA (US)

(73) Assignee: AREVA NP Inc., Lynchburg, VA (US)

(21) Appl. No.: 12/883,891

(22) Filed: Sep. 16, 2010

Related U.S. Application Data
(60) Provisional application No. 61/276,973, filed on Sep. 18, 2009.

(51) Int. Cl. G21C 15/00; B23P 6/00; B23P 17/00

(52) U.S. Cl. 376/372; 29/402.08; 29/402.06

(57) ABSTRACT

A method for retrofitting a boiling water reactor slip joint of a jet pump to reduce vibrations is provided. The method includes removing a mixing chamber from an existing slip joint defined by a diffuser and the mixing chamber, the existing slip joint defining an existing annular gap, and providing a new slip joint defining a new annular gap, the new annular gap being reshaped to permit reduced vibration. A jet pump and a method of operating a jet pump are also provided.

Priority to U.S. Provisional Patent Application Ser. No. 61/276,973 filed Sep. 18, 2009, is claimed, the entire disclosure of which is hereby incorporated by reference.

The present invention relates generally to a jet pump of a boiling water nuclear reactor and more specifically to a jet pump slip joint for vibration reduction.

### BACKGROUND

Jet pumps are used to circulate a coolant fluid, such as water, through the fuel core of a boiling water nuclear reactor. The jet pumps are located in a downcomer annulus between a shroud surrounding the core and the interior of the pressure vessel where the coolant is forced into the inlet end or bottom of the core. A slip joint is used along the length of the jet pump typically to accommodate differential thermal expansion that may occur along the jet pump. The slip joint typically has a narrow gap between two nearly concentric cylinders through which coolant fluid may pass under differential pressure.

Boiling water reactor jet pumps experience flow induced vibrations. Flow induced vibration occurs in leakage flow situations under certain circumstances such as flow through a narrow passage with a differential pressure imposed, among which include the BWR slip joint.

U.S. Pat. No. 3,378,456 discloses a jet pump means for a nuclear reactor. The configuration disclosed is what is known to one of skill in the art. The jet pump includes a nozzle, an inlet section, a mixer section and a diffuser section.

U.S. Pat. No. 4,285,770 discloses a jet pump seal configuration to reduce leakage by modifying the cylinder design to incorporate a labyrinth seal. The labyrinth seal is in the form of a series of flow expansion chambers which increase flow resistance and therefore decrease leakage flow. The expansion chambers may be provided by a series of spaced annular grooves formed in the mixer slip joint surface or in the diffuser slip joint

U.S. Pat. No. 3,378,456 teaches an increase, from bottom to top, in the annular gap (flow passage) size between the mixer and the diffuser. This is in the direction of the leakage flow through the slip joint. Although this helps facilitate putting the top piece in the bottom piece, these leave the slip joint unstable under flow conditions with sufficiently high differential pressure. U.S. Pat. No. 4,285,770 teaches attempting to reduce flow induced vibrations by attempting to decrease the flow rate through the slip joint at a constant pressure differential.

### SUMMARY OF THE INVENTION

An object of the present invention is to reduce the vibration of jet pumps associated with leakage flow in the slip joint and improve the stability at the slip joint.

A method for retrofitting a boiling water reactor slip joint of a jet pump to reduce vibrations is provided. The method includes removing a mixing chamber from an existing slip joint defined by a diffuser and the mixing chamber, the existing slip joint defining an existing annular gap, and providing a new slip joint defining a new annular gap, the new annular gap being reshaped to permit reduced vibration.

A jet pump of a boiling water nuclear reactor is also provided. The jet pump includes a mixing chamber and a diffuser positioned below the mixing chamber and receiving the mixing chamber at a slip joint such that an outer diameter of the mixing chamber is received in an inner diameter of the diffuser in a longitudinally slidable manner. Water leaks upward through the slip joint and at least one of the mixing chamber or the diffuser being shaped to provide an increased pressure profile to the water leaking upward.

A method of operating a jet pump is also provided. The method includes passing water downward through a mixing chamber into a diffuser and directing water leaking upward through a slip joint connecting the mixing chamber and the diffuser to reduce oscillations at the slip joint.

### BRIEF DESCRIPTION OF THE DRAWINGS

The present invention is shown with respect to the drawings in which:

FIG. 1 schematically shows the lower portion of a boiling water nuclear reactor;

FIG. 2 shows an isometric view of a jet pump assembly;

FIG. 3 shows an embodiment of a conventional slip joint;

FIG. 4 shows a slip joint according to a first embodiment of the present invention;

FIG. 5 shows a slip joint according to a second embodiment of the present invention;

FIG. 6 shows a slip joint according to a third embodiment of the present invention; and

FIG. 7 shows a slip joint according to a fourth embodiment of the present invention.

### DETAILED DESCRIPTION

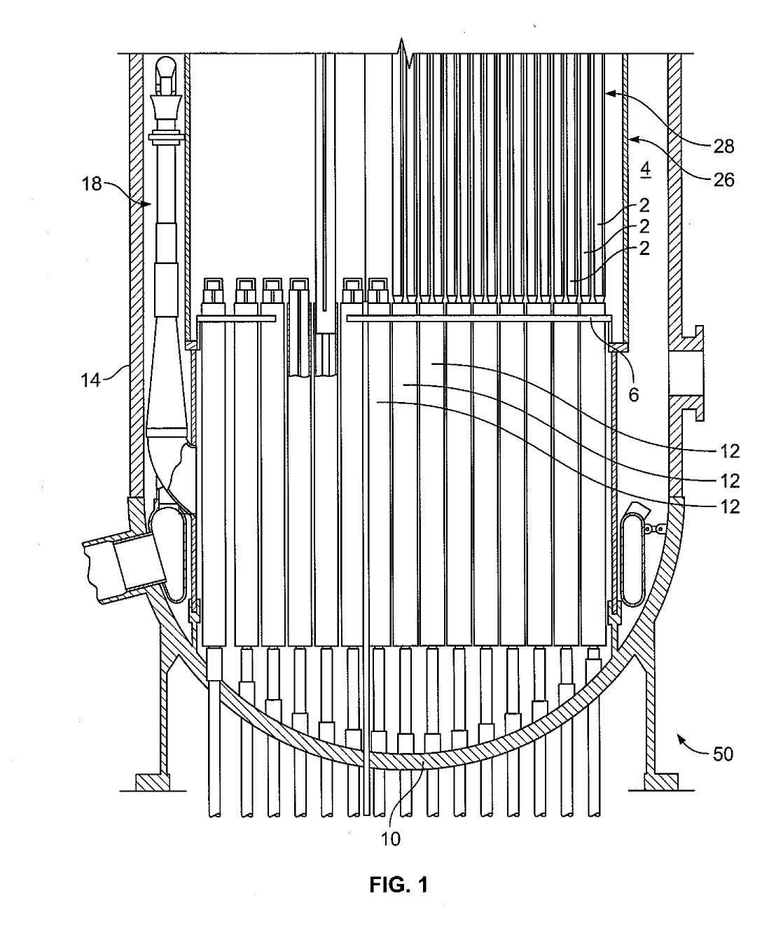

FIG. 1 schematically shows the lower portion of a boiling water nuclear reactor 50. Reactor 50 includes a pressure vessel 14 closed at a lower end by a dish shaped bottom head 10. A shroud 26 is located radially inside of pressure vessel 14. Between a wall of pressure vessel 14 and shroud 26 is a downcomer annulus 4. A reactor core fuel assembly 28 is housed inside of shroud 26, which comprises fuel assemblies 2. Fuel assemblies 2 may be arranged in groups of four, with each group being attached to guide tubes 12 at lower ends fuel assemblies 2. Upper ends of guide tubes 12 are sealed by a horizontal bottom grid plate 6 mounted across the bottom of shroud 26. Multiple jet pumps 18, one of which is shown schematically in FIG. 1, are mounted in downcomer annulus 4 circumferentially spaced about shroud 26.

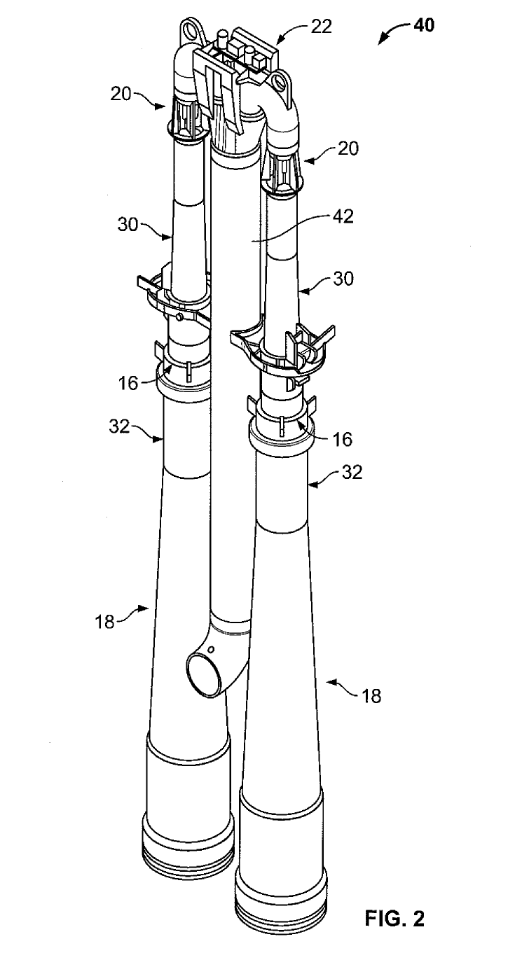

FIG. 2 shows an isometric view of a jet pump assembly 40. Jet pump assembly 40 includes two jet pumps 18 that are coupled to a riser pipe 42 by a ram's head 22. Water enters riser pipe 42, passes through ram's head 22 and is then driven downward into a mixing chamber 30 by drive nozzles 20. Mixing chamber 30 merges with a diffuser 32 at a slip joint 16, with mixing chamber 30 being independently supported with respect to diffuser 32 so that mixing chamber 30 is longitudinally slidable with respect to diffuser 32.

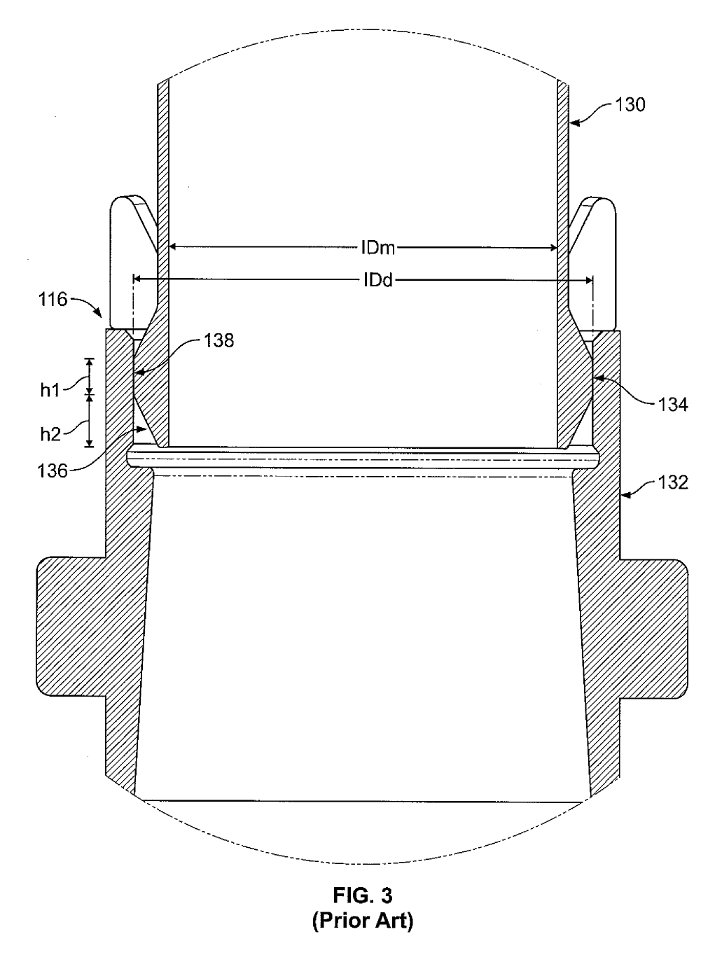

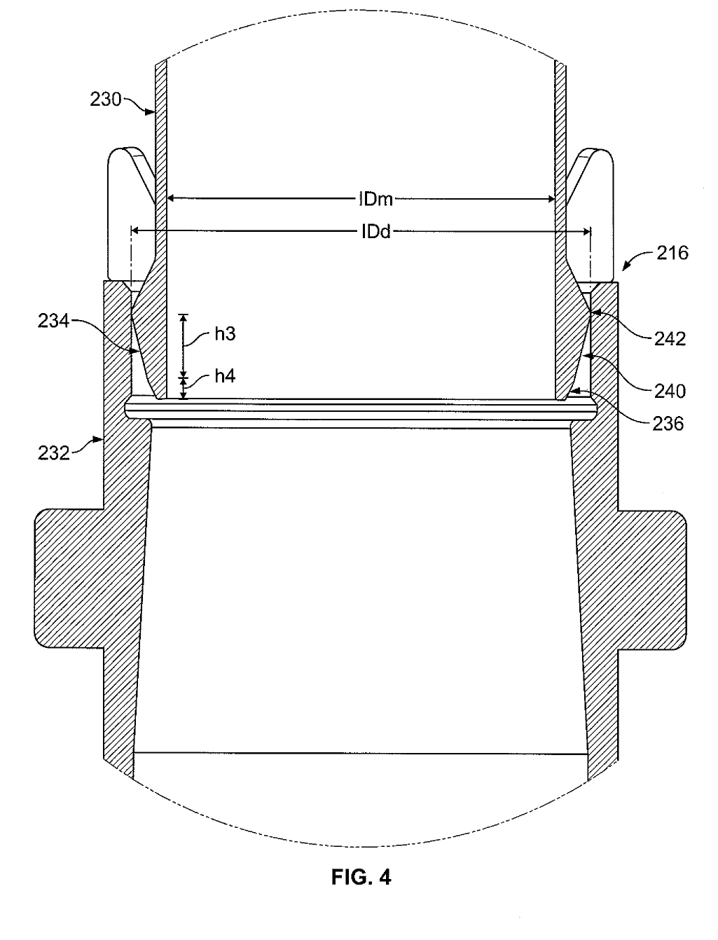

FIG. 3 schematically shows an embodiment of a conventional slip joint 116, in which the bottom of a mixing chamber 130 is positioned to be longitudinally slidable within the top of a diffuser 132. The bottom of mixing chamber 130 includes a gap forming portion 138 defined by an outer diameter of mixing chamber 130 that runs parallel to an inner diameter diffuser 132 so that radial distance of an annular gap 134, formed between mixing chamber 130 and diffuser 132 at slip joint 116, has constant width along the length of annular gap 134. At slip joint 116, annular gap 134, which is for example sized to be 0.008 inches (0.020 cm) wide and has a height hl of at least 1.0 inch (2.54 cm) to limit leakage, is formed between the parallel portions of an outer diameter of mixing chamber 130 and the inner diameter of diffuser 132 to allow mixing chamber 130 to slide within diffuser 132. Mixing chamber 130 has an inner diameter IDm of approximately 6 to 8 inches (15.2 cm to 20.3 cm) and diffuser 132, at slip joint 116, has an inner diameter IDd of approximately 7 to 9 inches (17.8 cm to 22.9 cm), such that the thickness of portion 138 is approximately 0.5 inches (1.27 cm). Below gap forming portion 138, mixing chamber 130 includes a lead-in portion 136 to allow for ease of inserting mixing chamber 130 into diffuser 132. Lead-in portion 136 has a height h2 of between 0.25 and 0.5 inches (0.64 cm to 1.27 cm) and converges over a width of lead-in portion 136 towards an inner diameter IDd of diffuser 132 to define a bottom of annular gap 134. As water is forced downward through mixing chamber 130 into diffuser 132, leakage occurs upward through slip joint 116 causing mixing chamber 130 to oscillate laterally, which causes mixing chamber 130 and diffuser 132 to disadvantageously vibrate and potentially impact each other. The change in the width of lead-in portion 136 is too large with respect to the change in height of lead-in portion 136 (i.e., the angle of slope of lead-in portion 136 vertically upward towards diffuser 132, which is for example 15 degrees, is too large) for the leakage to be able to force mixing chamber radially inward and prevent or limit the vibrations between mixing chamber 130 and diffuser 132.

FIG. 4 shows a slip joint 236 according to one embodiment of the present invention, in which the bottom of a mixing chamber 230 is slidably positioned within the top of a diffuser 232. The bottom of mixing chamber 230 includes a continuously tapered portion 240 forming an annular gap 234 that decreases in size between a bottom and a top of slip joint 216 to stabilize slip joint 216 under flow conditions. As a result, slip joint 216 may converge from bottom to top along substantially the entire length of annular gap 234 so portions of annular gap 234 are wider than the conventional annular gap 134 shown in FIG. 3. Mixing chamber 230 has an inner diameter IDm of approximately 6 to 8 inches (15.2 cm to 20.3 cm) and diffuser 232, at slip joint 216, has an inner diameter IDd of approximately 7 to 9 inches (17.8 cm to 22.9 cm), such that the thickness of portion 240 is approximately 0.5 inches (1.27 cm) at a radially exterior portion 242, or peak, of each continuously tapered portion 240. At slip joint 216, annular gap 234, which is for example sized to be 0.008 inches (0.020 cm) wide at radially exterior portion 242 and has a height h3 of for example of approximately at least 1.0 inch (2.54 cm), is formed between tapered portion 240 and inner diameter IDd of diffuser 232. Below tapered portion 240, mixing chamber 230 may include a lead-in portion 236 to allow for ease of inserting mixing chamber 230 into diffuser 232. Lead-in portion 236 may for example have a height h4 of between 0.15 and 0.4 inches (0.38 cm to 1.02 cm) and may converge over a width of lead-in portion 236 towards an inner diameter IDd of diffuser 232 at slip joint 216.

Above radially exterior portion 240, mixing chamber 230 converges inwardly toward diffuser 232, such that radially exterior portion 240 is formed by peaks of two opposing frusticonical portions coming substantially to a point to have approximately a V-shape. In other embodiments, radially exterior portion 240 may have approximately a U-shape or may include a portion that runs parallel to inner diameter IDd of diffuser 232. The radial width of annular gap 234 varies along the length of tapered portion 240, for example by approximately 1 to 5 degrees, most preferably by approximately 1 to 3 degrees, so tapered portion 240 directs water entering annular gap 234 to push against mixing chamber 230 and holds mixing chamber 230 radially away from diffuser 232 to prevent or limit mixing chamber 230 and diffuser 232 from contacting each other. The gradually varying width of annular gap 234, with respect to conventional annular gap 134, advantageously causes leakage to apply a radial force against mixing chamber 230 and helps hold mixing chamber 230 away from diffuser 232, preventing or reducing vibrations that could result if mixing chamber 230 and diffuser 232 contact one another.

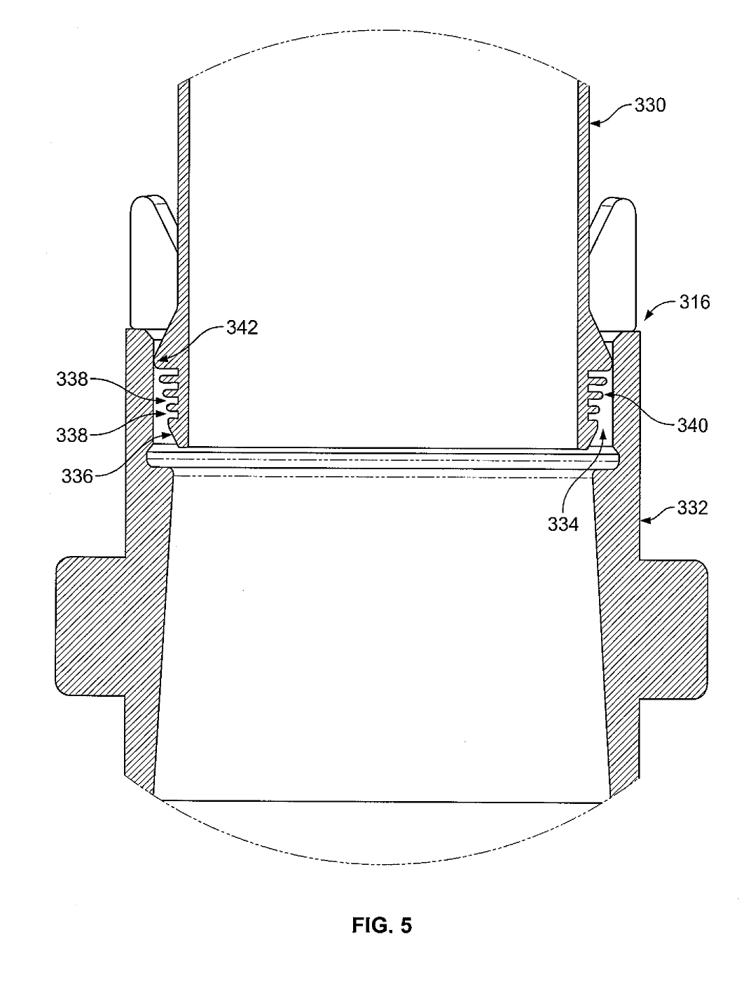

FIG. 5 shows a slip joint 316 according to another embodiment of the present invention, in which the bottom of a mixing chamber 330 is slidably positioned within the top of a diffuser 332. The bottom of mixing chamber 330 includes a continuously tapered portion 340 forming an annular gap 334 that decreases in size from the top of a lead-in portion 336 to a radially exterior portion 342 of mixing chamber 330 to stabilize slip joint 316 under flow conditions. Tapered portion 340 is formed similar to taper portion 240, converging approximately 1 to 5 degrees, most preferably 1 to 3 degrees, with the addition that tapered portion 340 is formed with a plurality of annular grooves 338 on the surface of tapered portion 340 so that tapered portion 340 includes a labyrinth-seal type feature. Grooves 338 may help further stabilize mixing chamber 330 by providing pockets in tapered portion 340 to receive additional force from water passing through annular gap 334.

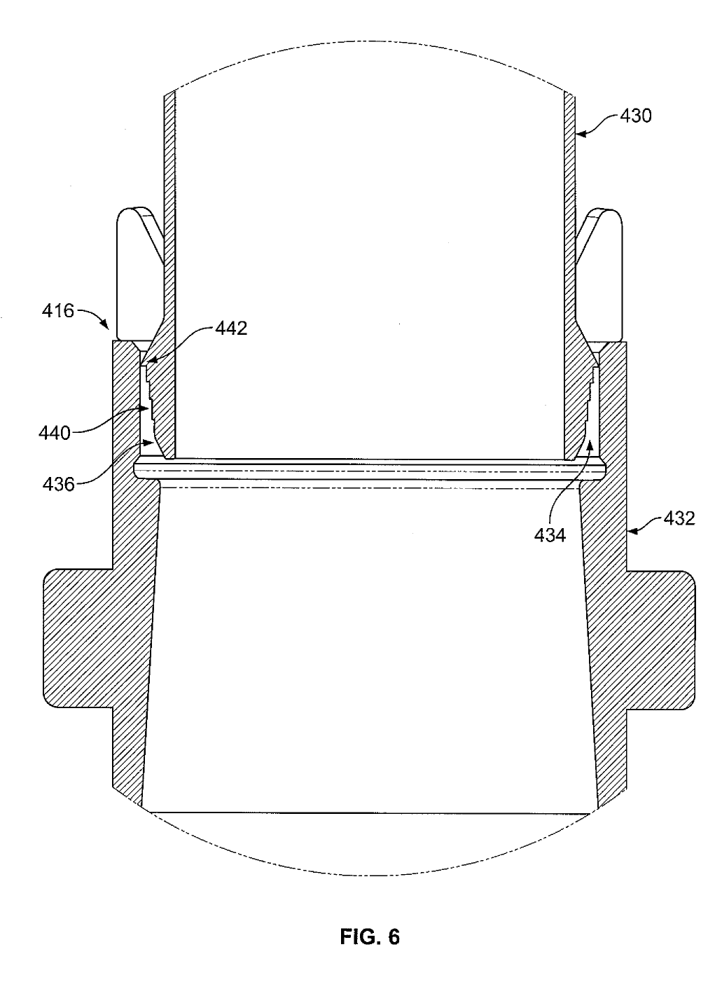

FIG. 6 shows a slip joint 416 according to one embodiment of the present invention, in which the bottom of a mixing chamber 430 is slidably positioned within the top of a diffuser 432. The bottom of mixing chamber 430 includes a stepped portion 440 forming an annular gap 434 that decreases in size from the top of a lead-in portion 436 to a radially exterior portion 442 of mixing chamber 430 to stabilize slip joint 416 under flow conditions. Stepped portion 440 is formed similar to taper portion 240, converging approximately 1 to 5 degrees, most preferably approximately 1 to 3 degrees.

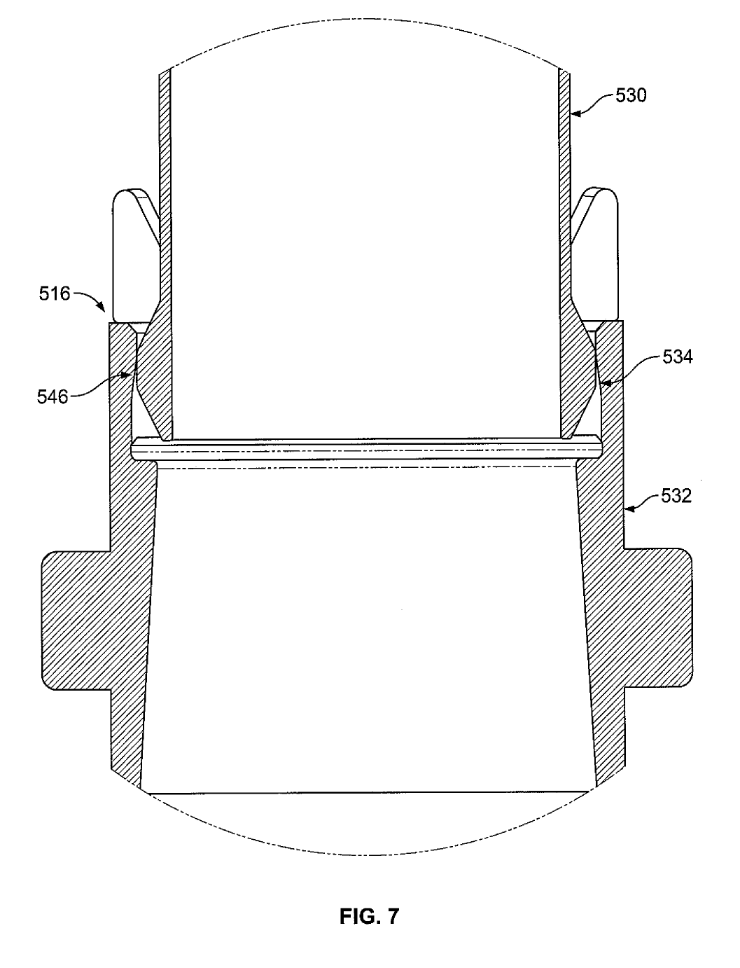

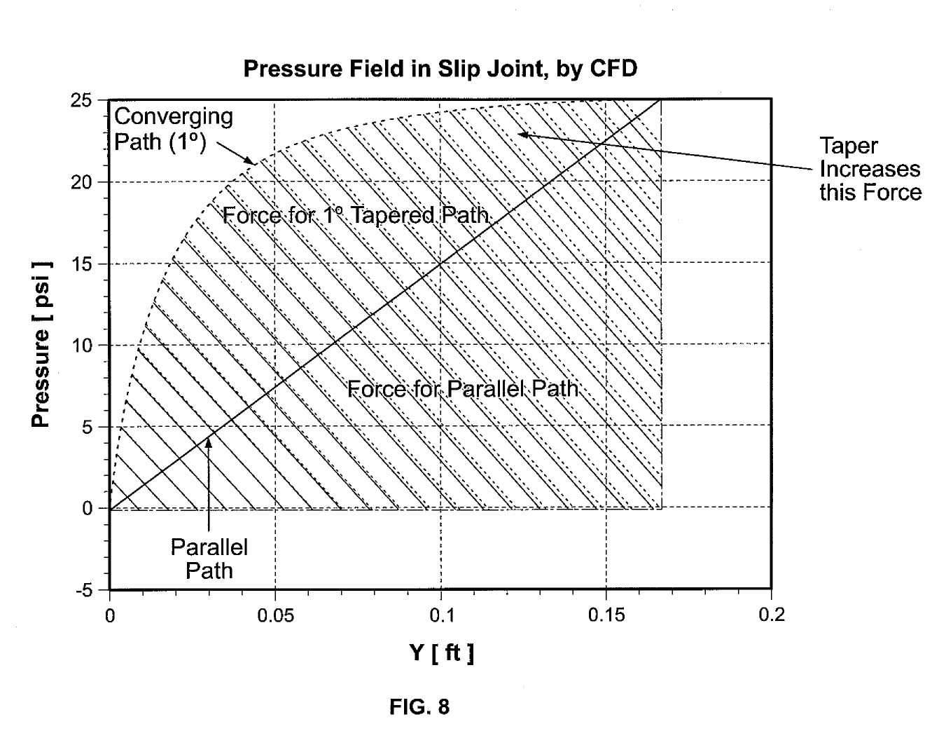

FIG. 7 shows a slip joint 516 according to one embodiment of the present invention, in which the bottom of a mixing chamber 530 is slidably positioned within the top of a diffuser 532. The bottom of mixing chamber 530 is formed with a constant outer diameter at an annular gap 534. However, annular gap 534 decreases in size because diffuser 532 includes a continuously tapered portion 546 that increases in width from top to bottom by approximately 1 to 5 degrees, most preferably 1 to 3 degrees, which may allow a sufficient volume of water to enter annular gap 534 to push mixing chamber 530 radially away from diffuser 532. Annular gap 534 advantageously may prevent or minimize vibrations between mixing chamber 530 and diffuser 532. In other embodiments, both the mixing chamber 530 and diffuser 532 may be continuously tapered from top to bottom. Also, tapered portion 546 of diffuser 532 may include grooves similar to grooves 338 (FIG. 5) so that tapered portion 546 includes a labyrinth-seal type feature. In a preferred embodiment, slip joint 516 only decreases in width between the bottom of slip joint 516 and the top of annular gap 534 and does not including any portion that increases in width.

FIG. 8 shows a graph illustrating the pressure profile in a slip joint, comparing a tapered annular gap converging at 1 degree in accordance with an embodiment of the present invention with an annular gap following a parallel path in accordance with a conventional slip joint. The graph plots pressure versus distance from the bottom of the annular gap for both the tapered annular gap and the parallel annular gap. As shown in FIG. 8, the tapered annular gap generates an increased pressure profile along the length of the slip joint than the parallel annular gap of the conventional slip joint.

The embodiments of the present invention described herein vary from conventional approaches in that, instead of attempting to reduce the amount of leakage through slip joint to reduce flow induced vibrations, the embodiments involve shaping slip joints 216, 316, 416, 516 to use the leakage itself to create force between the respective mixing chambers 230, 330, 430, 530 and respective diffusers 232, 332, 432, 532 to prevent or minimize vibrations.

In preferred embodiments, jet pumps 18 may be retrofitted to prevent or minimize vibrations. Retrofitting of jet pumps 18 may be achieved by retrofitting conventional mixing chamber 130 to form mixing chambers 230, 330, 430 or by retrofitting conventional diffuser 132 to form diffuser 532. This may be accomplished by removing mixing chamber 130 from conventional slip joint 116 defined by diffuser 132 and mixing chamber 130 and then removing material from mixing chamber 130 (i.e., portions of gap forming portion 138 and lead-in portion 136) or diffuser 132, for example by electrical discharge machining By machining existing slip joint 116 having existing annular gap 134, new slip joints 216, 316, 416, 516 defining new annular gaps 234, 334, 434, 534 are provided. Jet pump 18 may also be retrofitted by removing conventional mixing chamber 130 or conventional diffuser 132 from jet pump assembly 40, and then placing mixing chambers 230, 330, 430 or diffuser 532, or a portion thereof, in jet jump assembly 40. In embodiments where mixing chamber 130 or diffuser 532 are removed and replaced, tapered portions 240, 340 and stepped portion 440 may be formed in respective mixing chambers 230, 330, 430 during fabrication of mixing chambers 230, 330, 430 or may be machined therein after fabrication and tapered portions 546 may be formed in diffuser 532 during fabrication of diffuser 532 or may be machined therein after fabrication.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A method for retrofitting a boiling water reactor slip joint of a jet pump to reduce vibrations, comprising:
removing a mixing chamber from an existing slip joint defined by a diffuser and the mixing chamber, the existing slip joint defining an existing annular gap; and
providing a new slip joint defining a new annular gap, the new annular gap being reshaped to permit reduced vibration.

2. The method recited in claim 1 wherein the providing includes machining the mixing chamber to remove material.

3. The method recited in claim 1 wherein the providing includes providing a new mixing chamber or a new section of the mixing chamber to form the new slip joint.

4. The method recited in claim 1 wherein the providing includes machining the diffuser to remove material.

5. The method recited in claim 1 wherein the providing includes machining at least one of a mixing chamber or a diffuser to remove a portion of at least one of the mixing chamber or the diffuser such that when the mixing chamber and diffuser are joined to form the new slip joint an upwardly converging annular gap is formed between the mixing chamber and the diffuser.

6. The method recited in claim 5 wherein the machining is electrical discharge machining

7. The method recited in claim 5 wherein the machining includes removing a lead-in portion of the mixing chamber.

8. The method recited in claim 1 wherein the machining includes modifying the outer diameter of the mixing chamber such that the outer diameter converges toward the diffuser 1 to 5 degrees vertically upward at the slip joint.

9. The method recited in claim 1 wherein the machining includes modifying the inner diameter of the diffuser such that the inner diameter converges toward the mixing chamber 1 to 5 degrees vertically upward at the slip joint.

10. A jet pump of a boiling water nuclear reactor, comprising:
a mixing chamber; and
a diffuser positioned below the mixing chamber and receiving the mixing chamber at a slip joint such that an outer diameter of the mixing chamber is received in an inner diameter of the diffuser in a longitudinally slidable manner, water leaking upward through the slip joint and at least one of the mixing chamber or the diffuser being shaped to provide an increased pressure profile to the water leaking upward.

11. The jet pump recited in claim 10 wherein the slip joint includes an annular gap decreasing in size between a bottom of the slip joint and a top of the slip joint.

12. The jet pump recited in claim 11 wherein the outer diameter of the mixing chamber or the inner diameter of the diffuser varies by approximately 1 to 5 degrees at the annular gap.

13. The jet pump as recited in claim 11 wherein the mixing chamber increases in width between a radially interior portion of the outer diameter of the mixing chamber and a radially exterior portion of the outer diameter of the mixing chamber by approximately 1 to 5 degrees to decrease the annular gap.

14. The jet pump as recited in claim 13 wherein the mixing chamber is tapered or stepped between the radially exterior portion of the outer diameter of the mixing chamber and the radially interior portion of the outer diameter of the mixing chamber.

15. The jet pump as recited in claim 13 wherein the mixing chamber includes grooves formed therein between the radially exterior portion of an outer diameter of the mixing chamber and the radially interior portion of the outer diameter of the mixing chamber.

16. The jet jump as recited in claim 11 wherein the diffuser decreases in width between a radially exterior portion of the inner diameter of the diffuser and a radially interior portion of the inner diameter of the diffuser by approximately 1 to 5 degrees to decrease the annular gap.

17. The jet pump recited in claim 10 wherein the mixing chamber includes a lead-in portion for inserting the mixing chamber into the diffuser and a portion above the lead-in portion that converges vertically upward toward the diffuser between the lead-in portion and a radially exterior portion of the outer diameter of the mixing chamber.

18. A method of operating a jet pump comprising:
passing water downward through a mixing chamber into a diffuser; and
directing water leaking upward through a slip joint connecting the mixing chamber and the diffuser to reduce oscillations at the slip joint.

19. The method recited in claim 13 wherein the directing step is accomplished due to a shape of at least one of the mixing chamber or the diffuser at the slip joint.

20. The method recited in claim 14 wherein the directing step is accomplished by forming the mixing chamber or the diffuser to converge 1 to 5 degrees at the annular gap.
